(19) United States
(12) Patent Application Publication
(10) Pub. No.: US 2023/0301459 A1
(43) Pub. Date: Sep. 28, 2023

(54) Beverage-Dispensing Machine

(71) Applicant: STEINER AG WEGGIS, Weggis (CH)

(72) Inventor: Adrian Steiner, Weggis (CH)

(73) Assignee: STEINER AG WEGGIS, Weggis (CH)

(21) Appl. No.: 18/040,886

(22) PCT Filed: Jul. 29, 2021
(86) PCT No.: PCT/EP21/71288

§ 371 Date: Feb. 7, 2023

(30) Foreign Application Priority Data
Aug. 11, 2020 (CH) 00998/20

(51) Int. Cl. A47J 31/44; A47J 31/54; A47J 31/40; A47J 31/46

(52) U.S. Cl. CPC A47J 31/4485; A47J 31/54; A47J 31/4428; A47J 31/40; A47J 31/461

(57) ABSTRACT

A beverage-dispensing machine (10) comprises a cabinet housing (11), in which at least a coffee machine unit (16), a milk-frothing device, a water-heating device, an ice-feeding device (12) and an outlet unit (15) are located, the outlet unit being accessible at the front in the lower region of the coffee machine unit (16) and having a plurality of outlet openings (35) for the respective beverages. The ice-feeding device (12) is located above the coffee machine unit (16) in the cabinet housing (11). A tubular ice channel (20) leads to the outlet opening (35) of the outlet unit (15), and ice can be dropped through said tubular ice channel, said tubular ice channel (20) being composed of pieces which can be detached from each other. By means of this arrangement of the ice-feeding device and the ice channel, exact portions of ice can be dispensed in a simple way and without the risk of blockages. Because the ice channel is easy to assemble and disassemble, the ice channel can be completely cleaned and thus the required cleanliness of the ice channel is always ensured.

The invention relates to a beverage-dispensing machine for the dispensing of beverages, in particular of coffee, milk, chocolate, and/or mixed beverages, with a cabinet housing in which are located at least one coffee machine unit, a milk-frothing device, a water-heating device, an ice-feeding device, and an outlet unit which is arranged in the lower region of the coffee machine unit and accessible from the front side, with a plurality of outlet openings for the respective beverages, this being in accordance with the preamble to claim 1.

With a known beverage machine in accordance with the publication U.S. Pat. No. 2,897,509 B1 for the obtaining of hot or cold beverages, including coffee, milk beverages, tea, chocolate, syrup, aromatized beverages and ice, a cabinet chassis is provided, with a pivoting door on the front side, and within it the components required for the production of the beverages referred to, and also a master control system for the machine, by means of which the components are controlled and monitored, which can actuated by a user by means of a service system, in particular a touch screen. Used as the components are known modules for the brewing of coffee, for the heating of milk, or the production of milk froth, for the heating and provision of water, for the conveying of ice, syrup, etc., and containers with aroma substances, such as chocolate powder. In addition, a magazine is provided for the beakers which are to be used, and which can be taken from the front side of the chassis.

Taking this generic machine as a starting point, the invention is based on the object of improving a beverage-dispensing machine in such a way that the various different beverages can be produced and dispensed with it in high quality, and, in addition, an ice-feeding device is integrated for the dispensing of ice in portions, in such a way that a simple and reliable dispensing of ice in specific portions takes place and the cleaning of this device can be carried out with little effort.

This object is solved according to the invention by the features of claim 1.

In this situation, the ice-feeding device is arranged above the coffee machine unit in the cabinet housing, and from this a tubular ice channel leads as far as the outlet opening of the dispensing unit, through which the ice is let down in portions, wherein this tubular ice channel is composed of part sections which can be detached from one another.

With this arrangement of the ice-feeding device and of the ice channel, it is possible, in a simple manner and without the risk of blockage, for precise portions of ice to be dispensed, and, with the assembling and disassembling of the ice channel capable of being carrying out in just a few working steps, the complete cleaning of the channel is made possible and therefore the required cleanliness of the ice channel is ensured at all times.

Very advantageously, the ice-feeding device is controlled in such a way that a specific quantity of ice is let down in portions through the ice channel to the dispensing unit, integrated in which is a measuring means for the determination of the quantity of ice being let through, and by means of which the ice-feeding device is stopped when the required quantity of ice is reached. As a result, the quantity of the ice feed can be dispensed in a dosed or metered manner, even if the ice cubes are produced in different sizes.

The part sections of the ice channel are advantageously formed from an upper tube piece, connected to the ice-feeding device, a branch valve, and a lower tube piece opening into the outlet opening. As a result, this ice channel can, as mentioned heretofore, be easily assembled and disassembled.

This branch valve has proved to be a further substantial advantage of the invention, with a pivoting flap and a branch into an outflow tube, through which the ice can be guided into a catchment container or the like. Accordingly, this flap of the ice channel can close without the risk of the ice becoming jammed between the flap and the wall of the branch valve.

The invention and its further advantages are explained in greater detail hereinafter on the basis of exemplary embodiments and making reference to the drawings. The Figures show:

FIG. 1 is a partial front view of the beverage-dispensing machine according to the invention, in the opened state;

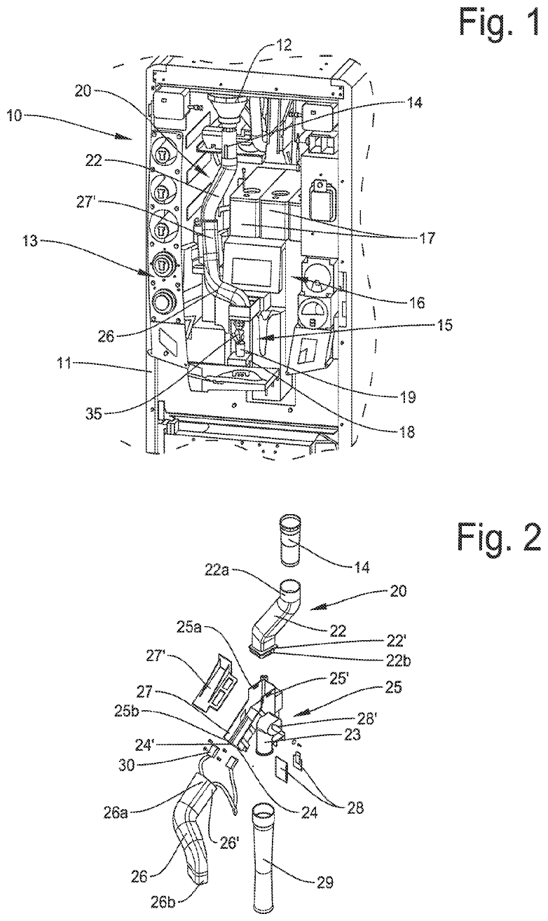

FIG. 2 is an exploded representation of an ice channel for installation in the beverage-dispensing machine according to FIG. 1;

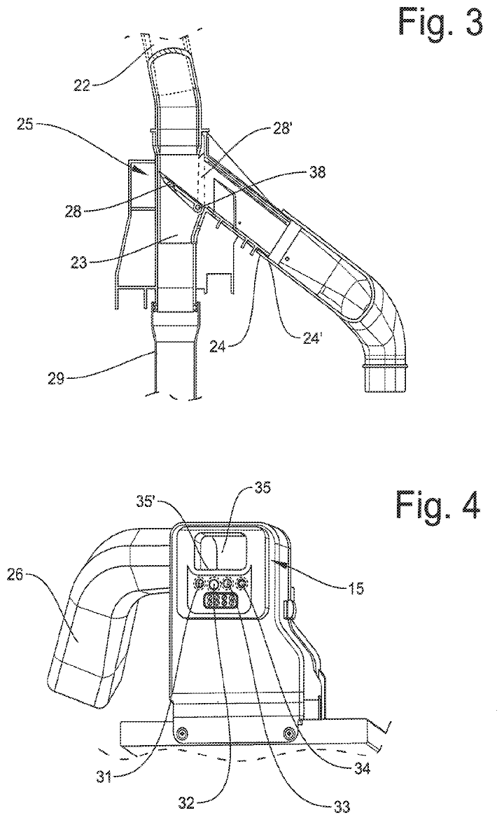

FIG. 3 is a longitudinal section with a partial view of the ice channel in the installed state; and

FIG. 4 is a view from beneath of an outlet unit of the beverage-dispensing machine according to FIG. 1.

FIG. 1 shows a beverage-dispensing machine 10 for the dispensing of beverages. This is particularly well-suited as an automatic beverage device, with which a plurality of beverages can be dispensed, such as, preferably, coffee, milk, tea, chocolate, and mixed beverages with aromas, wherein, as coffee, a choice can be made between espresso, normal coffee, cappuccino, and even latte macchiato. It is shown in the open state without the front side of the cabinet housing 11, wherein the front side is usually a horizontally pivoting door or the like, which can be opened for the cleaning, maintenance, and refilling of coffee beans, milk, and chocolate powder, and of fluid or powder-form aroma substances.

Accordingly, integrated in the cabinet housing 11 are in each case, among other elements, at least one coffee machine unit 16, with coffee bean containers 17, and a milk-frothing and water-heating device, wherein the latter is not visible. In addition, storage spaces for corresponding containers are provided for the delivery of fluid or powder-form aroma substances.

Arranged in the lower region of the coffee machine unit 16 is an outlet unit 15, and beneath this is a standing space for a drip container 18, accessible for a user from the front side, for a container 19, such as a cup, a beaker, a jug, or the like. The outlet unit 15 is provided with a plurality of outlet openings 31 to 34 for the respective beverages, and an additional outlet opening 35 for the ice, as can be seen in FIG. 4.

In addition, a magazine 13 is arranged next to the outlet unit 15, which preferably contains beakers 19 or the like, which in each case are made of a disposable material, such as plastic or cardboard. As a result, a user can draw an individual beaker 19 out of the magazine 13, place it on the standing surface of the drip container 18, and then select the desired beverage from a control panel, such as a touch screen. This touch screen is located on the front side close to the door, advantageously in the upper region of the cabinet housing 11, as close as possible at eye level for good access. A counting means can of course also be allocated to this beverage-dispensing machine 10, which is not represented in any greater detail.

According to the invention, an ice-feeder device 12 is placed in the cabinet housing 11 above the coffee machine unit 16, from which a tubular ice channel 20 runs as far as the outlet opening 35 of the outlet unit 15, and the ice is let down in portions, and wherein this ice channel 20 is composed of part sections which are detachable from one another.

Very advantageously, according to FIG. 2 these part sections are composed of an upper tubular part 22, connected to the ice-feeding device 12, a branch valve 25, and a lower tubular section 26 opening into the outlet opening 35. These part sections are in this situation only inserted into one another. Likewise, at the top, at the secured connection tube 14 of the ice-feeder device 12, and, respectively, at the bottom, the part sections are inserted without any securing means. They comprise in each case hubs 22a, 22b, 25a, 25b, 26a, 26b as tube end connections, into which the adjacent part sections connect in positive fit, and are additionally provided with engagement means 22′, 25, 26′, not shown in detail, at the hubs 22a, 22b, 25a, 25b, 26a, 26b, which, when the part sections are inserted into one another, engage with a minimal bending of the hubs, and lock in the inserted state, and disengage again when drawn apart. It is of course possible for these part sections to be locked or secured to one another in some other manner.

According to the invention, allocated to the branch valve 25 is a two-part flap 28, which can be driven by a rotary motor 28′ such as to pivot, and a branch element 23 is arranged below in an outflow tube 29, through which ice can be conveyed into a catchment container or the like, not shown in any greater detail, and melted. The upper angled tube piece 22, with its lower end at the hub 22b, and the outlet tube 29, connecting downstream to the branch valve 25, run approximately vertically and coaxially to one another. Conversely, the tube section 26, opening into the outlet opening 35, is connected to a support 27 of the branch valve 25, projecting away at an angle of less than 90°, preferably between 60° and 30° to the vertical. This tube section 26, after a predetermined length, then continues to run in a curve with the same oblique angle, and at the end is bent downwards and opens into the outlet opening 35.

The upper tube piece 22, the branch valve 25, and the lower tube section 26 are in each case provided partially with a circular cross-section and partially with a rectangular or square cross-section. The support 27 of the branch valve 25 and the tube section 26 are arranged in such a way that their lower sides 24 form a flat slide surface for the ice, i.e. such that, among other features, the lower face side 24′ of the support 27 extends approximately horizontally. This support 27 is provided on the top with a removable cover 27′, which allows for the removal of the two-part flap 28 from the branch valve 25. The cover 27′ can in this situation be located on the top of the support 27 with a plug or clamp connection. The flap 28 is in this situation held by a hinge 38 such that it can pivot, and is configured in such a way that it can likewise be removed for cleaning from the branch valve 25 manually, without tools, simply by releasing the hinge 38, and can then be refitted.

With these arrangements and the configuration of the part elements, the ice channel 20 can be assembled and disassembled in the machine rapidly and without any special technical knowledge being required, for cleaning or for other purposes. Advantageously, these part sections of the ice channel 20 are made of lightweight plastic parts, preferably silicone or similar materials.

Contained in the support 27, downstream of the flap 28, is a measuring means 30, which is shown only by way of indication, which preferably comprises a light barrier, by means of which the quantity of ice which is let through in portions can be determined, for example by counting the number of ice cubes.

FIG. 3 shows the branch valve 25 with this flap 28, which can be pivoted by the controllable rotary motor 28′, in the closed position of the outflow tube 29, and is closed in the closing position 28′ indicated by broken lines, in which this tube section 26 is closed. The latter position is also adopted in the de-energized state of the rotary motor 28′, so that no ice can unintentionally run out of the outlet opening.

The flap 28 is provided with a rectangular outer shape, which matches the cross-section shape of the branch valve 25, and is arranged in such a way with a hinge 38 that it can pivot about an axis in the branch valve 25, and that, in the closed position of the outflow tube 29 shown, it is aligned with its longitudinal extension in the same plane as the lower side 24 of the support 27 and of the tube section 26, in order to favour the throughput of the ice portions. In addition to this, a uniform cross-section of the ice channel 20 is provided with this branching arrangement, such that the ice, when falling down, does not accumulate at that location. In the closed position of the tube section 26, the flap 28 is positioned vertically, and it therefore forms an extended wall of the branch 23 leading into the outflow tube 29.

FIG. 4 shows the outlet unit 15 with this plurality of outlet openings 31, 32, 33, 34, arranged in nozzle fashion next to one another, for the respective outlet of the different beverages. These are in each case connected by means of lines, such as tubes or hoses, to the coffee machine unit 16, the milk-frothing device, the water-heating device, and containers for aromatic substances. As well as this, this outlet 35 for the ice is provided with a larger opening cross-section than the outlet openings 31 to 34 for the beverages. In this situation, it is configured as rectangular in shape and is arranged with its inner longitudinal side 35′ immediately next to these outlet openings 31 to 34, wherein the latter are located in a row so close to one another that, when a beaker 19 is placed on the standing surface, all of them lie within the upper opening region of the beaker, such that the beaker does not need to be moved and such that, due to the configuration of the standing surface, it is positioned on the drip container 18 beneath the outlet unit 15. This outlet 35 can of course, if required, also be of a different shape, such as circular, oval, or similar.

Advantageously, this ice-feeding device 12 is provided with an ice-producing device, which is not shown in any greater detail. The ice could also be emptied in bags into a cooler container in the cabinet housing 11, and drawn from this. The ice-feeding device 12 is provided with a motor-controlled conveying unit, such as what is referred to as a hopper motor, which is known and is not described in any greater detail, by means of which the ice can be let out in portions through the ice channel 20 into the container 19. This conveying unit can be controlled in this situation in such a way that the quantities of ice can be delivered in different portions as desired.

When a user makes a selection on the operating panel for the dispensing of a specific quantity of ice, the first step is for this conveying unit of the ice-feeding device 12 to be switched on, and, simultaneously or already before this, by the rotary motor 28′ being switched on, the flap 28 is pivoted into the position represented in FIG. 3, such that the ice falls down through the tube piece 22 to the flap 28, and then, on the slide surface 24, into a container 19 placed beneath. By the measuring means 30 in the support 27, the quantity of ice which is flowing is then measured, and, as soon as the selected amount has been let through, the tube section 26 is closed by the pivoting of the flap 28, as indicated by the broken lines in FIG. 3, and, at the same time the delivery unit is switched off. The latter device can also be adjusted in such a way that, after a predetermined period of time it is automatically switched off, and this period of time is adjusted at the next selection which follows, as a dependency of the quantity of ice which has previously been measured.

Advantageously, the rotary motor 28′ is provided with a position indicator, in order that it can be detected if the flap 28 has not pivoted into the respective closed position, for example if ice cubes have become jammed between the flap and the inner wall of the branch valve 25, or if an ice blockage were to be present in it, and the flap could no longer pivot.

In principle, this measuring means for the determination of the quantity of ice could be arranged at the outlet in the ice-feeding device, or it could also be possible for no measuring means to be provided, and only the controlling of the time duration or the like would be carried out at the conveying unit.

The invention has been adequately described with the exemplary embodiments presented. Other variants could, however, also be contemplated.

Depending on the size of the cabinet housing 11, and depending on the requirement, it would of course be possible for more or fewer part elements to be used in the ice channel. For example, the upper tube part, the branch valve, or the lower tube part could consist in each case of two part elements which could be detached from one another.

Likewise, depending on the spatial requirements in the cabinet housing, the ice channel can be configured in any desired manner, and therefore a high degree of flexibility for its installation can be rendered possible as a further advantage.

In principle, with a simpler configuration, it would also be possible to do without the branch valve and the outflow tube, and for only the ice channel to be provided.

1. Beverage-dispensing machine for dispensing beverages, in particular of coffee, milk, chocolate, and/or mixed beverages, with a cabinet housing (11), arranged in which are at least one coffee machine unit (16), a milk-frothing device, a water-heating device, an ice-feeding unit (12), and an outlet unit (15) in the lower region of the coffee machine unit (16), accessible from the front side, with a plurality of outlet openings (31 to 35) for the respective beverages, characterized in that the ice-feeding device (12) in the cabinet housing (11) is arranged above the coffee machine unit (16) and, from this, a tubular ice channel (20) leads to the outlet opening (35) of the outlet unit (15), and that the ice can be let down through this channel, wherein this tubular ice channel (20) is composed of part sections which can be detached from one another.

2. Beverage-dispensing machine according to claim 1, characterized in that the ice-feeding device (12) is controlled in such a way that a specific quantity of ice or a specific number of ice cubes are let down in portions through the ice channel (20) to the outlet unit, wherein a measuring means (30) is integrated into the ice channel (20) for detecting the quantity of ice let through or the number of ice cubes, by means of which the ice-feeding device (12) is stopped when the specified quantity of ice is attained.

3. Beverage-dispensing machine according to claim 1, wherein the part elements of the ice channel (20) are formed from an upper tubular piece (22), connected to the ice-feeding device (12), a branch valve (25), and a tube piece (26) opening lower down into the outlet opening (35).

4. Beverage-dispensing machine according to claim 3, characterized in that allocated to the branch valve (25) are a pivoting flap (28) and a branch element (28) into an outflow tube (29), through which the ice can be conveyed off into a catchment container or the like.

5. Beverage-dispensing machine according to claim 4, characterized in that the upper tube piece (22), with its lower end (22a), and the outflow tube (29) connecting downstream of the branch valve (25), run approximately vertically and coaxially to one another, while the tube piece (26) opening into the outlet opening (35) projects away from the branch valve (25) at an angle of less than 90°.

6. Beverage-dispensing machine according to claim 3, wherein at least the upper tube piece (22), the branch valve (25), and the tube section (26) are provided in each case over a part length with a rectangular cross-section, wherein the lower side of the pipe section (26) forms a slide surface (24) for the ice.

7. Beverage-dispensing machine according to claim 3, wherein the tube section (26) projects in linear fashion away from a support (27) of the branch valve (25), then runs in a curve and bends downwards at its lower end and opens into the outlet opening (35).

8. Beverage-dispensing machine according to claim 3, wherein the pivoting flap (28) can be adjusted by a controllable motor (28′) at the branch valve (25) into a closed position either of the tube section (26) or of the outflow tube (29), wherein, in the de-energized state of the motor (28′), the flap (28) closes the tube section (26).

9. Beverage-dispensing machine according to claim 3, wherein the flap (28) exhibits a rectangular outer shape, and is arranged in a hinge (38) such that it pivots about an axis in the branch valve (25), and that, in the closed position of the tube section (26), it is aligned vertically, and in those sections of the outflow tube (29) it is aligned as an extension of the slide surface (24) on the under side of the tube section (26).

10. Beverage-dispensing machine according to claim 1, wherein the outlet unit (15), with the plurality of outlet openings (31, 32, 33, 34) for the respective outlet of the beverages, arranged next to one another in a nozzle pattern, and the additional outlet opening (35) for ice, is provided with a larger opening cross-section than the outlet openings (31, 32, 33, 34) for the beverages.

11. Beverage-dispensing machine according to claim 1, wherein arranged in the cabinet housing (11), beneath the outlet unit (15), is a standing surface (15) of a drip container (18), accessible from outside, for a container (19) such as a cup or beaker.

12. Beverage-dispensing machine according to claim 3, wherein the upper tube piece (22), the branch valve (25), the pivoting flap (28) located in the valve, the tube section (26), and the outflow tube (29) of the ice channel (20) are in each case connected to one another in such a way that in each case they are connected together or secured in a detachable manner.

13. Beverage-dispensing machine according to claim 3, wherein the support (27) allocated to the branch valve (25) is provided with a removable cover (27′), which allows for the flap (28) to be removed from the branch valve.

14. Beverage-dispensing machine according to claim 13, characterized in that at least one measuring means (30) is contained in the support (27), downstream of the flap (28), which preferably comprises a light barrier, by means of which the quantity of ice allowed through or the number of ice cubes can be measured.

15. Beverage-dispensing machine according to claim 1, wherein the part pieces of the ice channel (20) are made of plastic parts, preferably of silicone or similar materials.
